(19) United States
(12) Patent Application Publication
(10) Pub. No.: US 2011/0154410 A1
(43) Pub. Date: Jun. 23, 2011

(54) COMMUNICATION APPARATUS AND CONTROL METHOD THEREOF

(75) Inventor: Joji FUJIYAMA, Oume-shi (JP)

(73) Assignee: KABUSHIKI KAISHA TOSHIBA, Tokyo (JP)

(21) Appl. No.: 12/897,560

(22) Filed: Oct. 4, 2010

(30) Foreign Application Priority Data
Dec. 21, 2009 (JP) 2009-289553

(51) Int. Cl. H04N 7/16

(52) U.S. Cl. 725/62

(57) ABSTRACT

According to one embodiment, a communication apparatus includes: a wireless communicating module configured to transmit data including an image to another communication apparatus through wireless communication and configured to control a directivity towards a direction at which a transmission state of wireless communication with the another communication apparatus is better; and a receiver configured to receive an operation command from a user, wherein the wireless communicating module is configured control the directivity to be fixed in a predetermined direction when an operation command for starting adjustment of an installation position of the communication apparatus or the another communication apparatus is received.

### CROSS-REFERENCE TO RELATED APPLICATIONS

This application is based upon and claims the benefit of priority from Japanese Patent Application No. 2009-289553, filed Dec. 21, 2009, the entire contents of which are incorporated herein by reference.

### FIELD

Embodiments described herein relate generally to a communication apparatus and a control method thereof.

### BACKGROUND

Communication apparatuses that transmit and receive data according to a wireless communication standard such as wireless high definition (HD) have dynamically adjusted the directivity of wireless communication utilizing phased array antenna technology in order to perform wireless communication stably even when obstacles and the like are present at a position between the communication apparatuses. In the wireless HD, when the highest quality images cannot be transmitted due to deterioration in the wireless transmission state, the resolution of the images may be reduced to lower the transmission rate to prevent disturbance in the displayed images.

Therefore, users do not need to care the installation positions of the communication apparatuses because an area where the communication apparatuses are installed without disturbing image transmitted to be displayed expands by dynamically adjusting the directivity of wireless communication and by reducing the resolution of the image.

However, users cannot know better installation positions for the wireless transmission state because the displayed image is not disturbed. For example, although images are not disturbed depending on the installation positions of the communication apparatuses, a sink device connected to the communication apparatuses may continuously display images with the reduced resolution. In such a situation, users who are fussy about image quality desire to know better installation positions for the wireless transmission state.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a network system according to an embodiment;

FIG. 2 is an exemplary table of logical addresses assigned to devices in the embodiment;

FIG. 3 is an exemplary block diagram of each of communication apparatuses in the embodiment;

FIG. 4 is an exemplary schematic plan view of a remote controller in the embodiment;

FIG. 5 is an exemplary schematic view of a display screen of a television in the embodiment;

FIG. 6 is an exemplary block diagram illustrating an adjustment of the installation positions of the communication apparatuses in the embodiment;

FIG. 7 is another exemplary block diagram illustrating an adjustment of the installation positions of the communication apparatuses in the embodiment;

FIG. 8 is still another exemplary block diagram illustrating an adjustment of the installation positions of the communication apparatuses in the embodiment;

FIG. 9 is still another exemplary block diagram illustrating an adjustment of the installation positions of the communication apparatuses in the embodiment;

FIG. 10 is an exemplary sequence diagram illustrating an operation in the network system in the embodiment;

FIG. 11 is an exemplary sequence diagram of a process when one of the communication apparatuses in the embodiment is operated;

FIG. 12 is an exemplary sequence diagram of a process when the other of the communication apparatuses in the embodiment is operated; and

FIG. 13 is an exemplary table illustrating operation contents of the communication apparatuses using the remote controller in the embodiment.

### DETAILED DESCRIPTION

In general, according to one embodiment of the invention, a communication apparatus comprises a wireless communicating module, and a receiver. The wireless communicating module is configured to transmit data including an image to another communication apparatus through wireless communication and configured to control a directivity towards a direction at which a transmission state of wireless communication with the another communication apparatus is better. The receiver is configured to receive an operation command from a user. the wireless communicating module is configured control the directivity to be fixed in a predetermined direction when an operation command for starting adjustment of an installation position of the communication apparatus or the another communication apparatus is received.

According to another embodiment of the invention, a communication apparatus comprises a wireless communicating module, a receiver, and a notification module. The wireless communicating module is configured to receive data including an image transmitted from another communication apparatus through wireless communication and configured to control a directivity towards a direction at which a transmission state of wireless communication with the another communication apparatus is better. The receiver is configured to receive an operation command from a user. The notification module is configured to notify a user of the transmission state. When an operation command for starting adjustment of an installation position of the communication apparatus or the another communication apparatus is received, the wireless communicating module controls the directivity to be fixed in a predetermined direction and the notification module starts notifying the user of the transmission state.

According to still another embodiment of the invention, a control method of a system comprising a first communication apparatus having a transmitter configured to transmit data including an image to a second communication apparatus through wireless communication and configured to control a directivity towards a direction at which a transmission state of the wireless communication with the second communication apparatus is better, the second communication apparatus having a specific receiver configured to receive the data including the image transmitted from the first communication apparatus through the wireless communication and configured to control a directivity towards a direction at which a transmission state of the wireless communication with the first communication apparatus is better and a notification module configured to notify a user of the transmission state, and a receiver configured to receive an operation command from a user, the control method comprising, when the receiver receives an operation command for starting adjustment of an installation position of the first communication apparatus or the second communication apparatus: controlling the directivity of at least one of the first communication apparatus and the second communication apparatus to be fixed in a predetermined direction; and starting notifying the user of the transmission state by the notification module.

An exemplary embodiment of a communication apparatus and a control method thereof will be described in detail hereinafter with reference to the accompanying drawings.

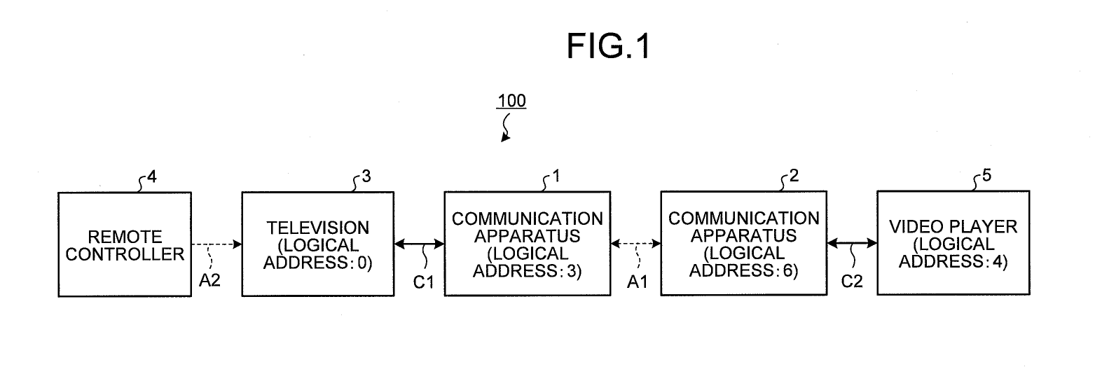

FIG. 1 is an exemplary block diagram of a network system 100. As illustrated in FIG. 1, the network system 100 includes communication apparatuses 1, 2, a television (TV) 3, a remote controller 4, and a video player 5.

The communication apparatuses 1, 2 transmit and receive a wireless HD signal to and from each other through wireless HD transmission A1. A high-definition multimedia interface (HDMI) connection cable C1 connects the communication apparatus 1 and the TV 3, and an HDMI connection cable C2 connects the communication apparatus 2 and the video player 5. For example, the communication apparatus 1 receives the wireless HD signal transmitted from the communication apparatus 2 and converts the received signal into an HDMI video signal, a consumer electronics control (CEC) signal, or a similar signal to transmit to a sink device such as the TV 3. The communication apparatus 1 also receives the CEC signal notified by the TV 3 in response to a remote control signal A2 received from the remote controller 4 and converts the received signal into the wireless HD signal to transmit to the communication apparatus 2. The communication apparatus 2 receives the HDMI video signal or the CEC signal from a source device such as the video player 5 and converts the received signal into the wireless HD signal to transmit to the communication apparatus 1. The communication apparatus 2 also receives the wireless HD signal transmitted from the communication apparatus 1 and converts the received signal into the CEC signal or a similar signal to transmit to the source device such as the video player 5.

The TV 3 displays and reproduces audio and video information received from television broadcasting, external devices, or the like. For example, the TV 3 displays and reproduces audio and video information that are output from the video player 5 and transmitted via the communication apparatuses 1, 2.

The remote controller 4 receives an operation performed by a user and transmits the remote control signal A2 for operating the TV 3 and the communication apparatuses 1, 2 and the video player 5 connected to the TV 3. The remote controller 4 includes operation buttons (described in detail later). When a user pushes the operation button, the remote controller 4 transmits the remote control signal A2 to the TV 3 corresponding to the pushed operation button. The remote control signal A2 may be transmitted from the remote controller 4 to the TV 3 through wireless communication, infrared-ray communication, or similar communication. When the remote control signal A2 transmitted is a signal for controlling the external device other than the TV 3, the TV 3 transmits the CEC signal corresponding to the remote control signal A2 to the external device.

The video player 5 is a reproducing device that reads video contents (audio and video information) stored in a large-capacity recording medium such as a magnetic tape, a digital versatile disc (DVD), a hard disk drive (HDD) to output to an external device such as the TV 3. For example, the video player 5 can output audio and video information stored in the DVD or a similar recording medium to the sink device such as the TV 3 connected to the video player 5 with the HDMI connection cable C2 or the like.

As described above, the communication apparatus 1 and the communication apparatus 2 transmit and receive the CEC signal according to the HDMI standard through the wireless HD transmission A1. Therefore, the TV 3 and the video player 5 connected to the communication apparatuses 1, 2 via the HDMI connection cables C1, C2 can realize such an operation that the TV 3 displays the image transmitted from the video player 5 by using the remote controller 4. This situation is the same as when the TV 3 and the video player 5 are directly connected to each other with an HDMI connection cable.

In the network system 100, each device of the communication apparatuses 1, 2, the TV 3, and the video player 5 performs an address resolution process by transmitting and receiving the HDMI CEC signal to assign a logical address to each device. In the embodiment, the logical address of 3 is assigned to the communication apparatus 1, the logical address of 6 is assigned to the communication apparatus 2, the logical address of 0 is assigned to the TV 3, and the logical address of 4 is assigned to the video player 5 as a result of performing the address resolution process.

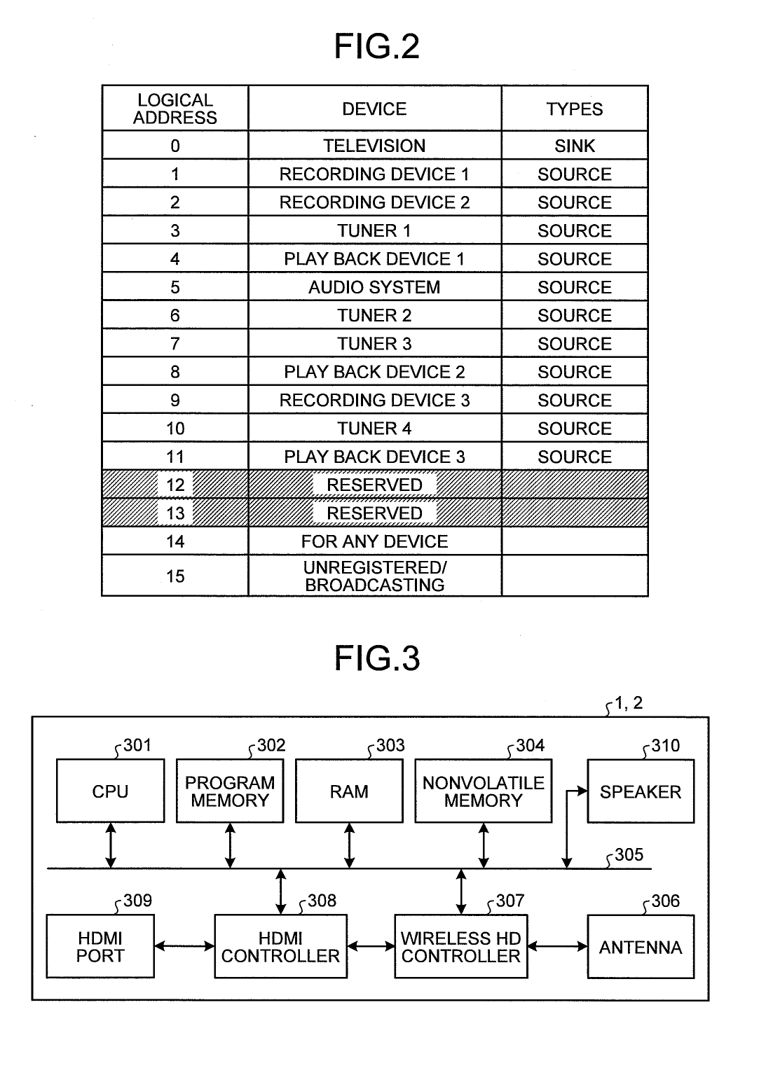

FIG. 2 is an exemplary table of logical addresses assigned to the devices and more specifically is a table illustrating a relationship between the logical address in the HDMI CEC standard and the device corresponding to the logical address. As illustrated in FIG. 2, the logical address of 0 is assigned to the sink device such as the TV. Three logical addresses of 1, 2, and 9 are assigned to the source devices including a recording function and a reproducing function, such as the video recorder (a recording device, for example). Four logical addresses of 3, 6, 7, and 10 are assigned to the source devices such as a television tuner. Three logical addresses of 4, 8, and 11 are assigned to the source devices including the reproducing function, such as a video player (a play back device, for example). A logical address of 5 is assigned to a device such as an audio amplifier (an audio system, for example). Two logical addresses of 12 and 13 are addresses that are previously reserved and cannot be used. A logical address of 14 is assigned to a second sink device when two sink devices such as TVs are present. A logical address of 15 is an address used before a logical address is assigned to the source device or when there is no logical address that can be assigned to the source device.

When a CEC message is transmitted to an individual device according to the HDMI CEC standard, the logical address assigned to the individual device is set in a destination field of the CEC message. In contrast, when a CEC message is broadcasted to all devices, the logical address of 15 is set in a destination field of the CEC message to indicate the broadcasting.

In the embodiment, unassigned logical addresses out of the logical addresses of 3, 6, 7, and 10 are utilized as logical addresses assigned to the communication apparatuses 1, 2. Specifically, the network system 100 illustrated in FIG. 1 includes no source device corresponding to the television tuner, and therefore, the logical addresses of 3 and 6 are assigned to the communication apparatuses 1, 2, respectively.

FIG. 3 is an exemplary block diagram of each of the communication apparatuses 1, 2 in the embodiment. As illustrated in FIG. 3, each of the communication apparatuses 1, 2 includes a central processing unit (CPU) 301, a program memory 302, a random-access memory (RAM) 303, a nonvolatile memory 304, an internal bus 305, an antenna 306, a wireless HD controller 307, an HDMI controller 308, an HDMI port 309, and a speaker 310.

The CPU 301 centrally controls operations of the communication apparatus. Specifically, the CPU 301 controls each module by outputting a control signal to each module on the internal bus 305 according to a computer program read out from the program memory 302. The program memory 302 is a read only memory (ROM) or a similar memory that stores therein computer programs.

The RAM 303 is volatile memory and is used as a working area for the CPU 301 to run a computer program. The nonvolatile memory 304 may be an electrically erasable and programmable ROM (EEPROM), a flash memory, or a similar memory. The nonvolatile memory 304 stores therein, for example, setting data related to the communication apparatus. The internal bus 305 is a data bus for transmitting and receiving various signals and reading and writing data, computer programs, or the like between the CPU 301 and each module that are connected to the internal bus 305.

The antenna 306 receives and transmits the wireless HD signal under control of the wireless HD controller 307. The wireless HD signal has a high rectilinear propagation because the wireless HD signal is transmitted in a 60-gigahertz millimeter wave band by the antenna 306. The antenna 306 includes a plurality of antenna elements (not specifically illustrated) and controls the directivity (directivity direction) of the wireless communication by utilizing phased array antenna technology in which the phases of radio waves radiated from the antenna elements are controlled by the wireless HD controller 307.

The wireless HD controller 307 converts video data (the HDMI video signal), a control signal (the CEC signal), and the like received from the HDMI controller 308 into the wireless HD signals to output to the antenna 306. The wireless HD controller 307 also converts the wireless HD signal received from the antenna 306, that is, the wireless HD signal received by the antenna 306 into the video data, the control signal, and the like to output to the HDMI controller 308.

Moreover, the wireless HD controller 307 controls the directivity of the antenna 306 according to the operation command received from a user using the remote controller 4 and the like (described in detail later) or depending on the wireless transmission state of the wireless communication by the antenna 306. For example, the wireless HD controller 307 checks the transmission state of the wireless HD signal transmitted from and received by the antenna 306, and if the transmission state is checked to be worse, the wireless HD controller 307 controls the directivity of the antenna 306 such that the transmission state becomes better. More specifically, the wireless HD controller 307 detects gain or an error ratio during reception, gain or an error ratio during transmission, and the like as the transmission state of the wireless communication by the antenna 306 and determines whether the detected value exceeds a predetermined threshold value (less than the threshold value for the gain and more than the threshold value for the error ratio). As a result of this determination, the wireless HD controller 307 detects deterioration of the transmission state. When the wireless HD controller 307 detects the deterioration of the transmission state, the wireless HD controller 307 searches for the directivity which results in the better transmission state in which the gain reaches the maximum and the error ratio reaches the minimum by changing the directivity of the antenna 306 in sequence to control the directivity depending on the search result.

Therefore, even when an obstacle such as a human occurs at a position between the communication apparatus 1 and the communication apparatus 2 to worsen the wireless transmission state between the communication apparatuses 1, 2, the directivity which results in the better transmission state is searched to control the directivity. Accordingly, the communication apparatus 1 and the communication apparatus 2 can stably continuously transmit the wireless HD signal having a high rectilinear propagation.

In a case that the transmission state after the wireless HD controller 307 controls the directivity of the antenna 306 does not return to a predetermined state and worsens (when the gain and the error ration do not exceed predetermined threshold values), the wireless HD controller 307 reduces a rate of when video data received from the HDMI controller 308 is converted into the wireless HD signal to be output to the antenna 306, in other words, the resolution of the video data transmitted from the antenna 306 to reduce a transmission rate.

The HDMI controller 308 outputs the video data, the control signals, and the like received from the HDMI port 309 to the wireless HD controller 307. The HDMI controller 308 also outputs the video data, the control signals, and the like received from the wireless HD controller 307 to the HDMI port 309. The HDMI port 309 is an interface for connecting one of the HDMI connection cables C1, C2, and the like to transmit and receive the HDMI data.

The speaker 310 outputs sound such as electronic sound based on the control signals received through the internal bus 305. Specifically, the CPU 301 outputs the control signal to the speaker 310 according to computer programs to control the sound output from the speaker 310. For example, when a user performs a specific operation, the volume of electronic sound output from the speaker 310 is controlled depending on the wireless transmission state of the antenna 306 (the gain and the error ratio during reception or the error ratio during transmission). Specifically, when the error ratio is the lowest level (when the transmission state is the best), the speaker 310 remains silent, and the volume gradually increases in correspondence with the increase in the error ratio (deterioration in the transmission state).

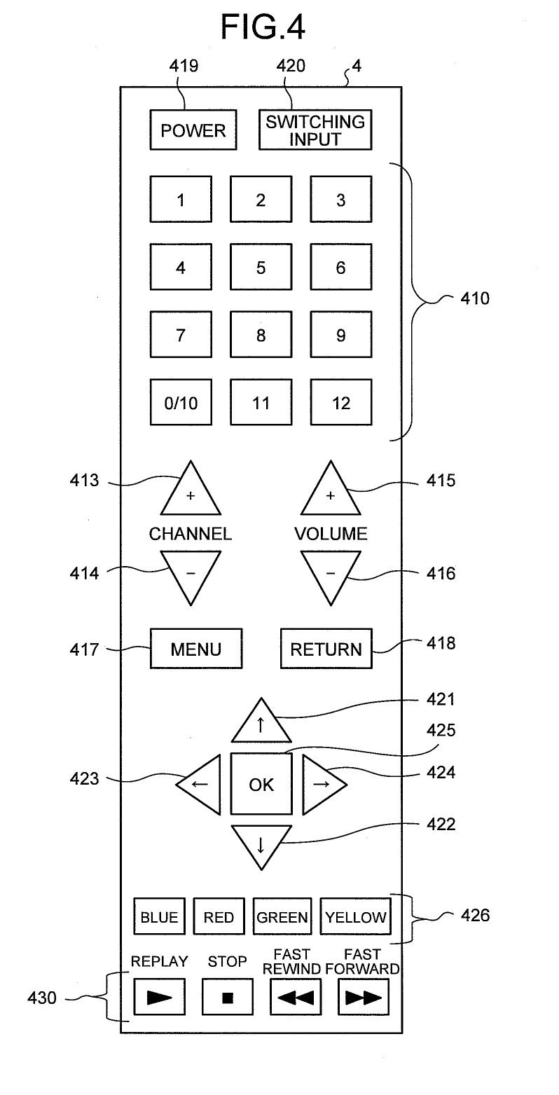

The remote controller 4 with which a user inputs an operation command in the network system 100 is described. FIG. 4 is an exemplary schematic plan view of the remote controller 4 illustrating a layout for operation buttons of the remote controller 4.

As illustrated in FIG. 4, various buttons for operating the TV 3 and each device connected to the TV 3 are arranged in the remote controller 4. Numeric buttons 410 are buttons for a user to enter numbers for entering channel numbers or for selecting numbers of connected devices during an input switching operation for switching the device to which the operation command is input.

A channel up button 413 and a channel down button 414 are buttons for a user to operate for changing channels in ascending order or descending order. A volume up button 415 and a volume down button 416 are buttons for a user to operate for increasing or reducing the volume of sound output.

A menu button 417 is a button for a user to operate for displaying a menu for, for example, a setting operation for the TV 3, and for starting the setting operation. A return button 418 is a button for a user to operate for finishing the setting operation and a similar operation.

A power button 419 is a button for a user to operate ON/OFF of the power of the TV 3. An input switching button 420 is a button for a user to operate for starting an input switching operation. In the embodiment, the input switching button 420 is also used when a device that is connected to the TV 3 and to which an operation command is input is switched to the communication apparatuses 1, 2 or the video player 5.

An up button 421, a down button 422, a left button 423, and a right button 424 are buttons for a user to operate for changing menu display during a setting operation or the position of a cursor. An OK button 425 is a button for a user to operate for determining a content to be selected and a content to be changed.

Color buttons 426 (“blue”, “red”, “green”, and “yellow” in the example illustrated) are buttons used by a user for performing an operation related to digital television broadcasting in the TV 3 or a similar operation. Source device control buttons 430 are buttons used by a user for performing an operation (reproduction, for example) related to a content stored in the source device connected to the TV 3. The operation includes “reproduction”, “stop”, “fast rewind”, and “fast forward” in the example illustrated.

A user can operate the TV 3 and each device connected to the TV 3 by operating the various buttons of the remote controller 4. In the embodiment, the remote controller 4 is also utilized for operating the communication apparatuses 1, 2.

FIG. 5 is an exemplary schematic view of a display screen G1 of the TV 3 and specifically illustrates the display screen G1 when an input switching operation is performed using the remote controller 4. When a user operates the input switching button 420 of the remote controller 4, the TV 3 goes into an input switching mode for selecting a device to be operated out of the connected devices to display the display screen G1.

As illustrated in FIG. 5, the display screen G1 displays a list of connected devices 501, 502, 503 that are connected to the TV 3 via the HDMI transmission. The connected device 501 is a device with a title of “WiHD-RX”, the connected device 502 is a device with a title of “WiHD-TX”, and the connected device 503 is a device with a title of “Player”. Data such as the titles of the connected devices 501, 502, 503 is notified to the TV 3 during the address resolution process.

In the input switching mode, a device to be operated is switched to a device corresponding to an operation of a button of the remote controller 4 out of the list of the connected devices 501, 502, 503 displayed on the display screen G1. For example, when “1” in the numeric buttons 410 is pressed during the input switching mode, the TV 3 switches a device to be operated using the remote controller 4 to the communication apparatus 1. When “2” in the numeric buttons 410 is pressed, the TV 3 switches a device to be operated using the remote controller 4 to the communication apparatus 2. When “3” in the numeric buttons 410 is pressed, the TV 3 switches a device to be operated using the remote controller 4 to the video player 5.

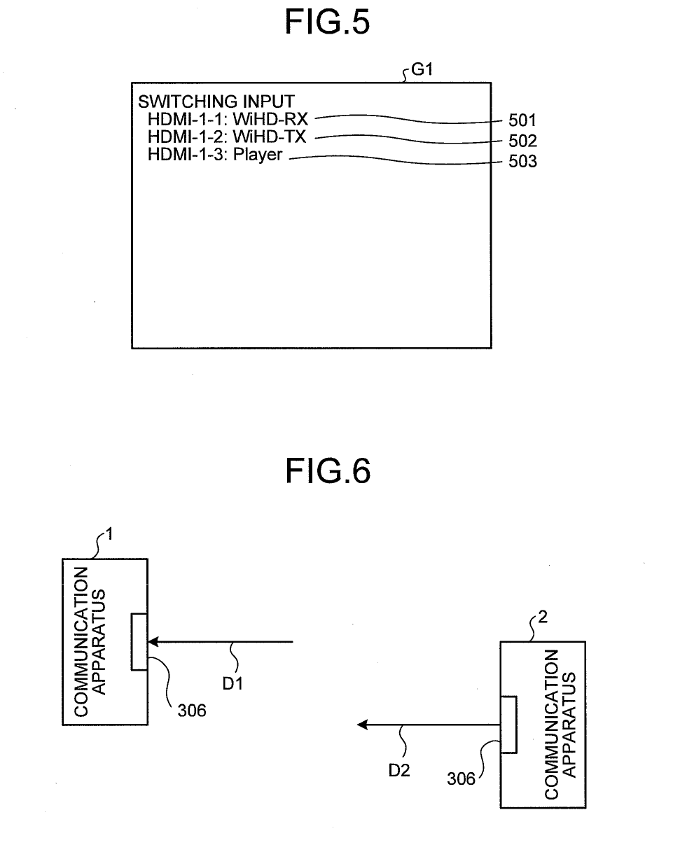

The adjustment of the installation positions of the communication apparatuses 1, 2 is described in detail below. FIG. 6 is an exemplary block diagram illustrating an adjustment of the installation positions of the communication apparatuses 1, 2. More specifically, FIG. 6 is an exemplary diagram illustrating an adjustment method when the antennas 306 of the communication apparatuses 1, 2 are installed so as to directly face against each other. The directivity in which gain during wireless transmission becomes the maximum in the antenna 306 is a front direction. In other words, the wireless transmission state of the wireless communication between the communication apparatuses 1, 2 can be the best by installing the antenna 306 of the communication apparatuses 1, 2 so as to directly face against each other.

As illustrated in FIG. 6, for adjusting the installation positions of the communication apparatuses 1, 2, a user inputs an operation command to the communication apparatus 1 by operating the remote controller 4 and sets an directivity D1 of the wireless signal received by the communication apparatus 1 to be fixed at the front. An output setting of electronic sound of the communication apparatus 1 is set so as to output electronic sound depending on the reception state of radio signal.

Meanwhile, an operation command is input to the communication apparatus 2 to fix an directivity D2 of the wireless signal transmitted from the communication apparatus 2 at the front and to fix the resolution of the image transmitted from the communication apparatus 2. The resolution is preferably fixed at the maximum value before the wireless HD controller 307 reduces the resolution to visually identify the image disturbance depending on deterioration of the transmission state.

Subsequently, a user inputs an operation command to the video player 5 by operating the remote controller 4 to reproduce an image content stored in the video player 5 on the TV 3.

Consequently, in each of the communication apparatus and the communication apparatus 2, no automatic control is performed by the wireless HD controller 307, such as the control of directivity depending on the transmission state of the antenna 306 or reducing the resolution of video data.

Therefore, images received from the video player 5 to be displayed on the TV 3 become better as the installation positions of the communication apparatus 1 and the communication apparatus 2 are close to a state in which the communication apparatuses 1, 2 directly face against each other. In contrast, the images are more disturbed as the positions are apart from the state in which the apparatuses 1, 2 directly face against each other. The volume of electronic sound output from the communication apparatus 1 becomes smaller as the installation positions of the communication apparatus 1 and the communication apparatus 2 are close to the state in which the communication apparatuses 1, 2 directly face against each other and becomes larger as the positions are apart from the state in which the communication apparatuses 1. 2 directly face against each other.

A user can set the communication apparatus 1 and the communication apparatus 2 so as to directly face against each other by adjusting the installation positions while checking the disturbance of images received from the video player 5 to be displayed on the TV 3 and the electronic sound output from the communication apparatus 1.

After the adjustment of the installation positions is completed, a user returns the setting of each of the communication apparatuses 1, 2 to a state before the installation positions are adjusted by operating the remote controller 4.

Specifically, the setting of the wireless HD controller 307 of the communication apparatus 1 is returned to normal so as to perform automatic control, such as the control of directivity depending on the wireless transmission state. The output setting of electronic sound of the communication apparatus 1 is set so as not to output electronic sound depending on the reception state of radio signal. Moreover, the setting of the wireless HD controller 307 of the communication apparatus 2 is returned to normal so as to perform automatic control, such as the control of directivity depending on the wireless transmission state or reducing the resolution of video data.

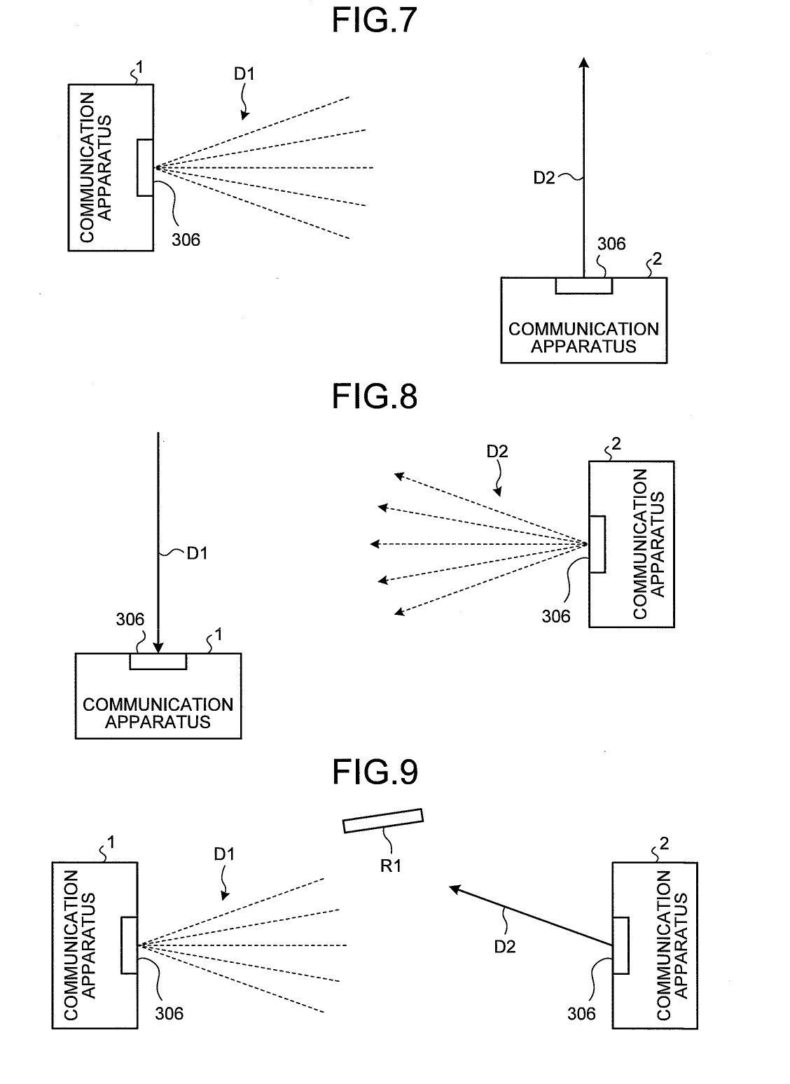

FIG. 7 is another exemplary block diagram illustrating an adjustment of the installation positions of the communication apparatuses 1, 2. More specifically, FIG. 7 is an exemplary block diagram illustrating an adjustment method of adjusting the installation position of the communication apparatus 2 so as to improve a wireless transmission state to the communication apparatus 1 whose installed position is fixed.

As illustrated in FIG. 7, for adjusting the installation position of the communication apparatus 2, a user inputs an operation command to the communication apparatus 1 by operating the remote controller 4 and sets the output setting of the electronic sound of the communication apparatus 1 to output electronic sound depending on the reception state of radio signal.

An operation command is input to the communication apparatus 2 to fix the directivity D2 of the wireless signal transmitted from the communication apparatus 2 at the front and to fix the resolution of the image transmitted from the communication apparatus 2.

Subsequently, a user inputs an operation command to the video player 5 by operating the remote controller 4 to reproduce an image content stored in the video player 5 on the TV 3.

Consequently, in the communication apparatus 2, no automatic control is performed by the wireless HD controller 307, such as the control of directivity depending on the transmission state of the antenna 306 or reducing the resolution of video data.

Therefore, images received from the video player 5 to be displayed on the TV 3 become better as the installation position of the communication apparatus 2 is close to a position where the communication apparatus 1 readily receives the radio signal transmitted from the communication apparatus 2. In contrast, the images are more disturbed as the position of the communication apparatus 2 is apart from the position where the communication apparatus 1 readily receives the radio signal transmitted from the communication apparatus 2. The volume of electronic sound output from the communication apparatus 1 becomes smaller as the installation position of the communication apparatus 2 is close to the position where the communication apparatus 1 readily receives the radio signal transmitted from the communication apparatus 2 and becomes larger as the installation position of the communication apparatus 2 is apart from the position.

A user can set the communication apparatus 2 at a position where the wireless transmission state to the communication apparatus 1 is better by adjusting the installation position of the communication apparatus 2 while checking the disturbance of images received from the video player 5 to be displayed on the TV 3 and the electronic sound output from the communication apparatus 1.

After the adjustment of the installation position is completed, a user returns the setting of each of the communication apparatuses 1, 2 to a state before the installation position is adjusted by operating the remote controller 4.

Specifically, the output setting of electronic sound of the communication apparatus 1 is set so as not to output electronic sound depending on the reception state of radio signal. Moreover, the setting of the wireless HD controller 307 of the communication apparatus 2 is returned to normal so as to perform automatic control, such as the control of directivity depending on the wireless transmission state or reducing the resolution of video data.

FIG. 8 is still another exemplary block diagram illustrating an adjustment of the installation positions of the communication apparatuses 1, 2. More specifically, FIG. 8 is an exemplary block diagram illustrating an adjustment method of adjusting the installation position of the communication apparatus 1 so as to improve a wireless transmission state to the communication apparatus 2 whose installed position is fixed.

As illustrated in FIG. 8, for adjusting the installation position of the communication apparatus 1, a user inputs an operation command to the communication apparatus 1 by operating the remote controller 4 and sets the directivity D1 of the wireless signal received by the communication apparatus 1 to be fixed at the front. An output setting of electronic sound of the communication apparatus 1 is set so as to output electronic sound depending on the reception state of radio signal.

An operation command is input to the communication apparatus 2 to fix the resolution of the image transmitted from the communication apparatus 2.

Subsequently, a user inputs an operation command to the video player 5 by operating the remote controller 4 to reproduce an image content stored in the video player 5 on the TV 3.

Consequently, in the communication apparatus 1, no automatic control is performed by the wireless HD controller 307, such as the control of directivity depending on the transmission state of the antenna 306.

Therefore, images received from the video player 5 to be displayed on the TV 3 become better as the installation position of the communication apparatus 1 is close to a position where the communication apparatus 1 readily receives the radio signal transmitted from the communication apparatus 2. In contrast, the images are more disturbed as the position of the communication apparatus 1 is apart from the position where the communication apparatus 1 readily receives the radio signal transmitted from the communication apparatus 2. The volume of electronic sound output from the communication apparatus 1 becomes smaller as the installation position of the communication apparatus 1 is close to the position where the communication apparatus 1 readily receives the radio signal transmitted from the communication apparatus 2 and becomes larger as the installation position of the communication apparatus 1 is apart from the position.

A user can set the communication apparatus 1 at a position where the wireless transmission state to the communication apparatus 2 is better by adjusting the installation position of the communication apparatus 1 while checking the disturbance of images received from the video player 5 to be displayed on the TV 3 and the electronic sound output from the communication apparatus 1.

After the adjustment of the installation position is completed, a user returns the setting of each of the communication apparatuses 1, 2 to a state before the installation position is adjusted by operating the remote controller 4.

Specifically, the setting of the wireless HD controller 307 of the communication apparatus 1 is returned to normal so as to perform automatic control, such as the control of directivity depending on the wireless transmission state. The output setting of electronic sound of the communication apparatus 1 is set so as not to output electronic sound depending on the reception state of radio signal. Moreover, the setting of the wireless HD controller 307 of the communication apparatus 2 is returned to normal so as to perform automatic control, such as reducing the resolution of video data.

FIG. 9 is still another exemplary block diagram illustrating an adjustment of the installation positions of the communication apparatuses 1, 2. More specifically, FIG. 9 is an exemplary block diagram illustrating an adjustment method of adjusting the installation position of a reflector R1 when wireless transmission between the communication apparatus 1 and the communication apparatus 2 is performed via the reflector R1. The installation positions of the communication apparatus 1 and the communication apparatus 2 are fixed when the installation position of the reflector R1 is to be adjusted.

The reflector R1 may be a flat object that is made of a material easily reflecting a radio signal and is made into a shape easily reflecting the radio signal. The reflector R1 of which the surface is made of metal material, the shape of the surface is smooth, and the size of the surface is sufficiently larger than the wavelength of the radio signal is suitable for efficiently reflecting the radio signal.

As illustrated in FIG. 9, for adjusting the installation position of the reflector R1, a user inputs an operation command to the communication apparatus 1 by operating the remote controller 4 and sets the output setting of the electronic sound of the communication apparatus 1 to output electronic sound depending on the reception state of radio signal.

Meanwhile, an operation command is input to the communication apparatus 2 to fix the directivity D2 of the wireless signal transmitted from the communication apparatus 2 in a direction at which the reflector R1 is to be installed (for example, 30 degrees in an upper direction or 30 degrees in a right direction) and to fix the resolution of the image transmitted from the communication apparatus 2.

Subsequently, a user inputs an operation command to the video player 5 by operating the remote controller 4 to reproduce an image content stored in the video player 5 on the TV 3.

Consequently, in the communication apparatus 2, no automatic control is performed by the wireless HD controller 307, such as the control of directivity depending on the transmission state of the antenna 306 or reducing the resolution of video data.

Therefore, images received from the video player 5 to be displayed on the TV 3 become better as the installation position (such as installation angle) of the reflector R1 is close to a position where the radio signal transmitted from the communication apparatus 2 is readily reflected to the communication apparatus 1.

In contrast, the images are more disturbed as the position of the reflector R1 is apart from the position where the radio signal transmitted from the communication apparatus 2 is readily reflected to the communication apparatus 1. The volume of electronic sound output from the communication apparatus 1 becomes smaller as the installation position of the reflector R1 is close to the position where the radio signal transmitted from the communication apparatus 2 is readily reflected to the communication apparatus 1 and becomes larger as the installation position of the reflector R1 is apart from the position.

A user can set the reflector R1 at a position where the transmission state is better when the radio signal is reflected at the reflector R1 by adjusting the installation position of the reflector R1 while checking the disturbance of images received from the video player 5 to be displayed on the TV 3 and the electronic sound output from the communication apparatus 1.

After the adjustment of the installation position is completed, a user returns the setting of each of the communication apparatuses 1, 2 to a state before the installation position is adjusted by operating the remote controller 4.

Specifically, the output setting of electronic sound of the communication apparatus 1 is set so as not to output electronic sound depending on the reception state of radio signal. Moreover, the setting of the wireless HD controller 307 of the communication apparatus 2 is returned to normal so as to perform automatic control, such as the control of directivity depending on the wireless transmission state or reducing the resolution of video data.

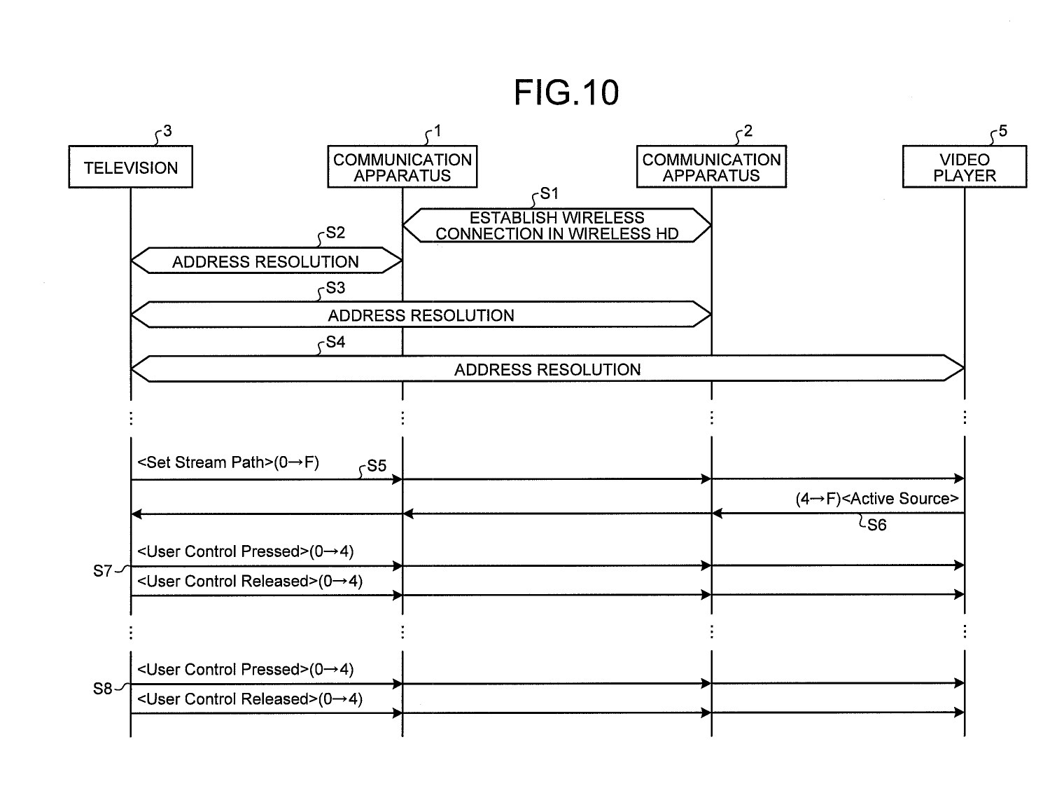

FIG. 10 is an exemplary sequence diagram illustrating the operation in the network system 100. More specifically, FIG. 10 is an exemplary sequence diagram illustrating a process of establishing wireless connection between the communication apparatuses 1, 2, an address resolution process of performing an address resolution in the HDMI CEC of each device, and a process when a user operates the video player 5 using the remote controller 4.

As illustrated in FIG. 10, at S1, wireless connection in the wireless HD is established between the communication apparatuses 1, 2. After S1, the network system 100 is in a state capable of communicating between the communication apparatus 1 and the communication apparatus 2.

At S2, the communication apparatus 1 performs an address resolution process in the HDMI CEC and obtains the logical address in the HDMI CEC. At S3, The communication apparatus 2 performs an address resolution process in the HDMI CEC and obtains the logical address in the HDMI CEC. At S4, the video player 5 performs an address resolution process in the HDMI CEC and obtains the logical address in the HDMI CEC.

The wireless connection between the communication apparatus 1 and the communication apparatus 2 is established, and the logical address in the HDMI CEC is assigned to each device of the network system 100 at the processes S1 to S4, which enables each device to communicate with each other in the CEC.

S5 to S8 indicate processes when a user operates the video player 5 after the completion of the wireless connection and the address resolution in the HDMI CEC.

At S5, the TV 3 broadcasts a message <Set Stream Path> to switch a device to be operated to the video player 5 by an operation performed by a user using the remote controller 4 (the operation of the input switching button 420 and “3” in the numeric buttons 410, for example).

At S6, the video player 5 broadcasts a message <Active Source> in response to the message <Set Stream Path> broadcasted by the TV 3.

At S7, the TV 3 transmits a message <User Control Pressed> and a message <User Control Released> to the video player 5 to reproduce an image content stored in the video player 5 by an operation performed by a user using the remote controller 4 (the operation of “reproduction” in the source device control buttons 430, for example). Based on these messages, the video player 5 recognizes that “reproduction” in the source device control buttons 430 is operated to start reproducing the image content.

At S8, the TV 3 transmits a message <User Control Pressed> and a message <User Control Released> to the video player 5 to stop the reproduction of the image content by an operation performed by a user using the remote controller 4 (the operation of “stop” in the source device control buttons 430, for example). Based on these messages, the video player 5 recognizes that “stop” in the source device control buttons 430 is operated to stop reproducing the image content.

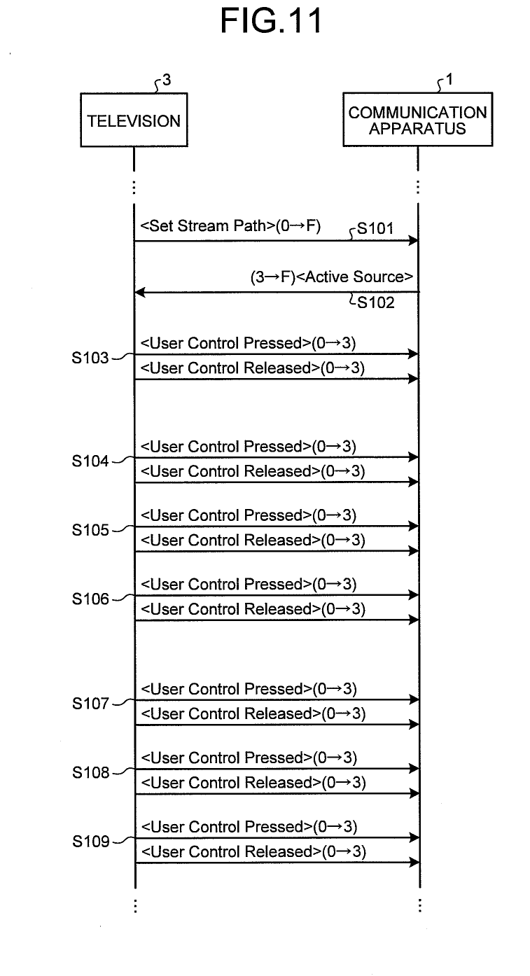

FIG. 11 is an exemplary sequence diagram of a process when the communication apparatus 1 is operated. The operation content of the communication apparatus 1 using the remote controller 4 is described in detail later.

As illustrated in FIG. 11, at S101, the TV 3 broadcasts a message <Set Stream Path> to switch a device to be operated to the communication apparatus 1 by an operation performed by a user the remote controller 4 (the operation of the input switching button 420 and “1” in the numeric buttons 410, for example).

At S102, the communication apparatus 1 broadcasts a message <Active Source> in response to the message <Set Stream Path> broadcasted by the TV 3.

At S103, the TV 3 transmits a message <User Control Pressed> and a message <User Control Released> to the communication apparatus 1 to set the output setting of electronic sound to output electronic sound depending on the reception state of radio signal by an operation performed by a user using the remote controller 4 (the operation of “green” in the color buttons 426, for example). Based on these messages, the communication apparatus 1 recognizes that “green” in the color buttons 426 is operated and sets the output setting of electronic sound to output electronic sound depending on the reception state of radio signal.

At S104 to S106, the TV 3 transmits messages <User Control Pressed> and messages <User Control Released> to the communication apparatus 1 to set the directivity of radio signal received (vertical direction) to be fixed by an operation performed by a user using the remote controller 4 (the operation of the up button 421 and “0” and “0” in the numeric buttons 410, for example). Based on these messages, the communication apparatus 1 recognizes that the up button 421 (S104), and “0” (S105) and “0” (S106) in the numeric buttons 410 are operated to control the directivity of radio signal received to be fixed at 0 degree in a vertical direction.

At S107 to S109, the TV 3 transmits messages <User Control Pressed> and messages <User Control Released> to the communication apparatus 1 to set the directivity of radio signal received (horizontal direction) to be fixed by an operation performed by a user using the remote controller 4 (the operation of the right button 424 and “0” and “0” in the numeric buttons 410, for example). Based on these messages, the communication apparatus 1 recognizes that the right button 424 (S107), and “0” (S108) and “0” (S109) in the numeric buttons 410 are operated and to control the directivity of radio signal received to be fixed at 0 degree in a horizontal direction.

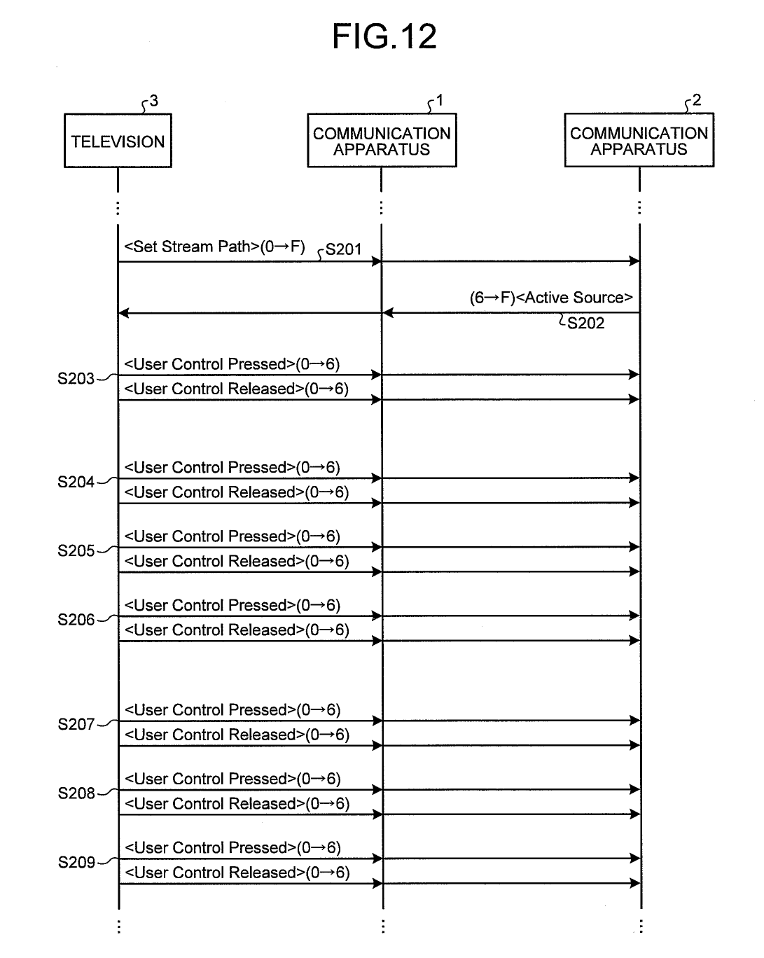

FIG. 12 is an exemplary sequence diagram of a process when the communication apparatus 2 is operated. The operation content of the communication apparatus 2 using the remote controller 4 is described in detail later.

As illustrated in FIG. 12, at S201, the TV 3 broadcasts a message <Set Stream Path> to switch a device to be operated to the communication apparatus 2 by an operation performed by a user using the remote controller 4 (the operation of the input switching button 420 and “2” in the numeric buttons 410, for example).

At S202, the communication apparatus 2 broadcasts a message <Active Source> in response to the message <Set Stream Path> broadcasted by the TV 3.

At S203, the TV 3 transmits a message <User Control Pressed> and a message <User Control Released> to the communication apparatus 2 to set the resolution of the image transmitted to be fixed by an operation performed by a user using the remote controller 4 (the operation of “blue” in the color buttons 426, for example). Based on these messages, the communication apparatus 2 recognizes that “blue” in the color buttons 426 is operated to set the resolution of the image transmitted to be fixed. Specifically, the resolution is set to be fixed at the maximum value before the wireless HD controller 307 reduces the resolution.

At S204 to S206, the TV 3 transmits messages <User Control Pressed> and messages <User Control Released> to the communication apparatus 2 to set the directivity of radio signal transmitted (vertical direction) to be fixed by an operation performed by a user using the remote controller 4 (the operation of the down button 422 and “1” and “5” in the numeric buttons 410, for example). Based on these messages, the communication apparatus 2 recognizes that the down button 422 (S204), and “1” (S205) and “5” (S206) in the numeric buttons 410 are operated to control the directivity of radio signal transmitted to be fixed at 15 degrees in a vertical direction.

At S207 to S209, the TV 3 transmits messages <User Control Pressed> and messages <User Control Released> to the communication apparatus 2 to set the directivity of radio signal transmitted (horizontal direction) to be fixed by an operation performed by a user using the remote controller 4 (the operation of the left button 423 and “3” and “0” in the numeric buttons 410, for example). Based on these messages, the communication apparatus 2 recognizes that the left button 423 (S207), and “3” (S208) and “0” (S209) in the numeric buttons 410 are operated to control the directivity of radio signal received to be fixed at 30 degrees in a horizontal direction.

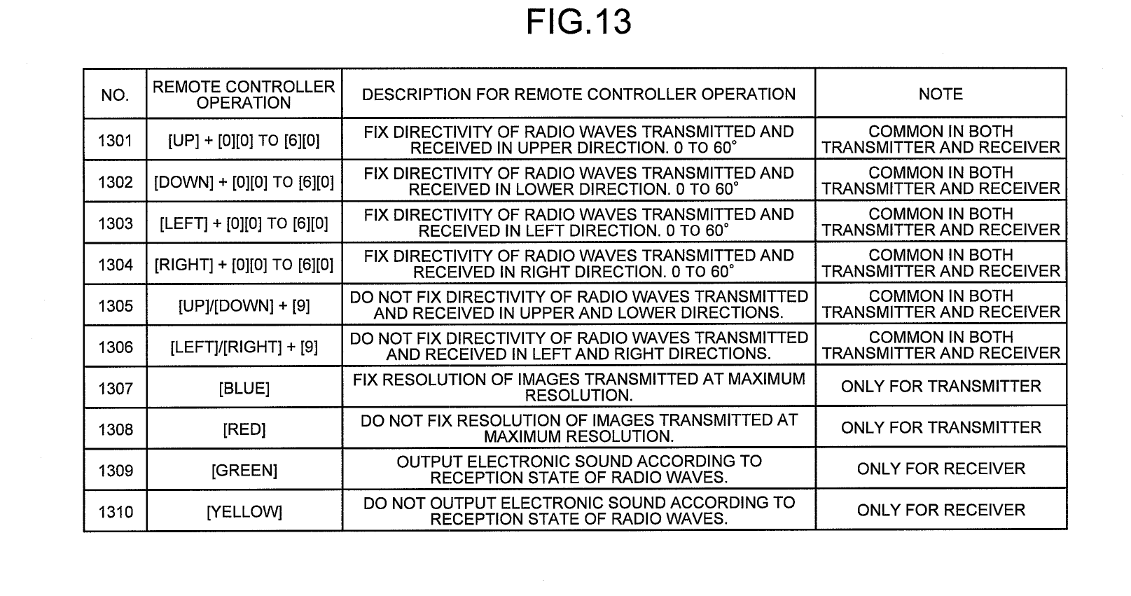

Operation methods of the communication apparatuses 1, 2 using the remote controller 4 are described below. FIG. 13 is an exemplary table illustrating operation contents of the communication apparatuses 1, 2 using the remote controller 4.

As illustrated in FIG. 13, the directivity of radio signal transmitted from and received by the communication apparatuses 1, 2 is set at an optional angle in a vertical direction upward or downward (a range on design is within 0 degree to 60 degrees in both up and down directions) using the up button 421 or the down button 422 and by inputting a two digit number using the numeric buttons 410.

The directivity of radio signal transmitted from and received by the communication apparatuses 1, 2 is set at an optional angle in a horizontal direction leftward or rightward (a range on design is within 0 degree to 60 degrees in both left and right directions) using the left button 423 or the right button 424 and by inputting a two digit number using the numeric buttons 410.

The control of the directivity of radio signal transmitted from and received by the communication apparatuses 1, 2 in the vertical direction is returned to automatic control by operating the up button 421 or the down button 422 and “9” in the numeric buttons 410. The control of the directivity of radio signal transmitted from and received by the communication apparatuses 1, 2 in the horizontal direction is returned to automatic control by operating the left button 423 or the right button 424 and “9” in the numeric buttons 410.

The resolution of images transmitted from the communication apparatus 2 is controlled to be fixed at the maximum by operating “blue” in the color buttons 426. The resolution of images transmitted from the communication apparatus 2 is returned to automatic control by operating “red” in the color buttons 426. An output setting of electronic sound of the communication apparatus 1 is set so as to output electronic sound depending on the reception state of radio signal by operating “green” in the color buttons 426. An output setting of electronic sound of the communication apparatus 1 is set so as not to output electronic sound depending on the reception state of radio signal by operating “yellow” in the color buttons 426.

As described above, when the network system 100 receives an operation command for starting the adjustment of the installation position of the communication apparatus 1 or the communication apparatus 2 from the remote controller 4, at least one of the communication apparatus 1 and the communication apparatus 2 is controlled such that the directivity of wireless communication is fixed towards a predetermined direction, and the communication apparatus 1 starts notification of the wireless transmission state. For example, when the communication apparatus 1 receives an operation command for starting the adjustment of the installation position of the communication apparatus 1 or the communication apparatus 2 from the remote controller 4, the communication apparatus 1 controls the directivity of wireless communication in the antenna 306 to be fixed towards a predetermined direction to start notification of the wireless transmission state with the speaker 310. On the other hand, when the communication apparatus 2 receives an operation command for starting the adjustment of the installation position of the communication apparatus 2 or the communication apparatus 1 from the remote controller 4, the communication apparatus 2 controls the directivity of wireless communication in the antenna 306 to be fixed towards a predetermined direction.

Accordingly, for example, as illustrated in FIG. 6 to FIG. 9, a user can adjust the installation positions of the communication apparatuses 1, 2 and the reflector R1 while checking the disturbance of images received from the video player 5 to be displayed on the TV 3 and the electronic sound output from the communication apparatus 1. By the adjustment, the communication apparatuses 1, 2 and the reflector R1 can be set at the installation positions where the wireless transmission states are better.

In the embodiment a structure is exemplified in which the speaker 310 of the communication apparatus 1 outputs electronic sound depending on the reception state of radio signal. However, the module that outputs electronic sound depending on the reception state of radio signal is not limited to the speaker 310 of the communication apparatus 1. For example, electronic sound may be output from the speaker of the TV 3 by mixing sound data output from the communication apparatus 1 to be received by the TV 3 and data of electronic sound depending on a reception state of radio signal.

During the adjustment of the installation positions, video data transmitted from the communication apparatus 2 to the communication apparatus 1 may be stored in not only the video player 5 connected to the communication apparatus 2 but also the nonvolatile memory 304 of the communication apparatus 2 and the like in advance. When the communication apparatus 1 or the communication apparatus 2 receives an operation command for starting the adjustment of the installation positions, the directivity to be fixed may be set based on information previously set in the nonvolatile memory 304 and the like as well as the operation using the remote controller 4. For example, a front direction at which the gain in the antenna 306 during wireless transmission becomes the maximum may be previously set in the nonvolatile memory 304.

The embodiment produces an effect that enables a user to set a communication apparatus dynamically adjusting the directivity of wireless communication and the resolution of the image at an installation position where the wireless transmission state is better.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a wireless communicating module configured to transmit data comprising an image to a second communication apparatus through wireless communication and configured to control a directivity to improve a transmission state of wireless communication with the second communication apparatus; and
a receiver configured to receive an operation command from a user,
wherein the wireless communicating module is configured fix the directivity in a predetermined direction when an operation command for starting adjustment of an installation position of the communication apparatus or the second communication apparatus is received.

2. The communication apparatus of claim 1, further comprising:
a controller configured to control transmission to the second communication apparatus to reduce resolution of the image depending on deterioration of the transmission state, wherein
the controller is configured to control the resolution to be fixed at a predetermined resolution when the operation command for starting adjustment of the installation position of the communication apparatus or the second communication apparatus is received.

3. The communication apparatus of claim 1, wherein the wireless communicating module is configured to fix the directivity in a direction at which gain during transmission is substantially maximum.

4. The communication apparatus of claim 1, wherein the wireless communicating module is configured to fix the directivity at an angle when an operation command indicating the angle is received in association with the operation command for starting adjustment of the installation position of the communication apparatus or the second communication apparatus.

5. The communication apparatus of claim 1, wherein the wireless communicating module is configured to wirelessly communicate with the second communication apparatus according to wireless high definition (HD) standard.

6. A communication apparatus comprising:
a wireless communicating module configured to receive data comprising an image transmitted from a second communication apparatus through wireless communication and configured to control a directivity to improve a transmission state of wireless communication with the second communication apparatus;
a receiver configured to receive an operation command from a user; and
a notification module configured to notify a user of the transmission state, wherein
when an operation command for starting adjustment of an installation position of the communication apparatus or the second communication apparatus is received, the wireless communicating module is configured to fix the directivity in a predetermined direction and the notification module is configured to start notifying the user of the transmission state.

7. The communication apparatus of claim 6, wherein the notification module is configured to notify with sound notification corresponding to the transmission state.

8. The communication apparatus of claim 6, wherein the wireless communicating module is configured to fix the directivity in a direction at which gain during transmission is substantially maximum.

9. The communication apparatus of claim 6, wherein the wireless communicating module is configured to fix the directivity at an angle when an operation command indicating an angle is received in association with the operation command for starting adjustment of the installation position of the communication apparatus or the another communication apparatus.

10. The communication apparatus of claim 6, wherein the wireless communicating module is configured to wireless communicate with the second communication apparatus according to wireless high definition (HD) standard.

11. A control method of a system comprising a first communication apparatus comprising a transmitter configured to transmit data comprising an image to a second communication apparatus through wireless communication and configured to control a directivity to improve a transmission state of the wireless communication with the second communication apparatus, the second communication apparatus comprising a predetermined receiver configured to receive the data comprising the image transmitted from the first communication apparatus through the wireless communication and configured to control a directivity to improve a transmission state of the wireless communication with the first communication apparatus and a notification module configured to notify a user of the transmission state, and a receiver configured to receive an operation command from a user, the control method comprising, when the receiver receives an operation command for starting adjustment of an installation position of the first communication apparatus or the second communication apparatus:
controlling the directivity of at least one of the first communication apparatus and the second communication apparatus to be fixed in a predetermined direction; and
starting notifying the user of the transmission state by the notification module.
